(19) United States
(12) Patent Application Publication
(10) Pub. No.: US 2013/0205201 A1
(43) Pub. Date: Aug. 8, 2013

(54) Touch Control Presentation System and the Method thereof

(71) Applicants: Pao-Te Tsai, Hsinchu County (TW); Wen-Kai Wu, Kaohsiung City (TW); Po-Tsang Li, Taichung City (TW); Po-Yu Chen, Hsinchu County (TW); Jing-Ru Chiu, Hualien County (TW); Kuan-Chu Hou, Hsinchu County (TW); Chien-Hung Huang, Tainan City (TW); Allan Lin, Taipei City (TW); Wen-Lung Tsai, New Taipei City (TW); Chung-Ming Lin, Taoyuan County (TW)

(72) Inventors: Pao-Te Tsai, Hsinchu County (TW); Wen-Kai Wu, Kaohsiung City (TW); Po-Tsang Li, Taichung City (TW); Po-Yu Chen, Hsinchu County (TW); Jing-Ru Chiu, Hualien County (TW); Kuan-Chu Hou, Hsinchu County (TW); Chien-Hung Huang, Tainan City (TW); Allan Lin, Taipei City (TW); Wen-Lung Tsai, New Taipei City (TW); Chung-Ming Lin, Taoyuan County (TW)

(73) Assignee: PHIHONG TECHNOLOGY CO.,LTD., Taoyuan County (TW)

(21) Appl. No.: 13/368,609

(22) Filed: Feb. 8, 2012

(51) Int. Cl. G06F 17/00

(52) U.S. Cl. 715/249; 715/252

(57) ABSTRACT

A method of operating presentation through a multi-touch panel, comprises steps of providing a presenting module having a format transformation module, user interface generator and presenting/reading mode switching module to a system; activating the presenting module and display interface generated by the user interface generator on a multiple-touch panel of the system, wherein the interface generated by the user interface generator includes a shrinkage image area to display the non-activated file, an operation area to display file which is activated and a buffer zoon to allow a user drag file in the shrinkage image area to the operation area, thereby activating the dragged file.

### FIELD OF THE INVENTION

The present invention relates to a computer touch control system, and more particularly to a touch control presentation system and the method of the same.

### BACKGROUND OF THE INVENTION

Recently, the touch panel and technologies are widely used in consumer product. The touch-control to the virtual object within the display increases convenience. Especially, it allows the user to control the image enlarging, shrinking and object rotation function by user finger.

Currently, the computer is the typical tool during the teaching and meeting for presentation. However, the computer and the projector should be prepared before the teaching or the business presentation, and followed by projecting the information onto the screen. The one who presents the information can write none information on the screen, it is inconvenient to the user. A blackboard or whiteboard is required to fulfill the requirements for the presentation. The user needs many equipments and the setup of device is complicated and time-consuming.

Therefore, large-size electronic panel is development to replace the white board. The computer output the information onto the display of the electronic panel, which is so called the electronic whiteboard. An electronic pen is provided to allow the user to write the text onto the display, even store or print out the text and take note. Some of the electronic panels offer the function to record and display the image file.

However, there are some drawbacks to the electronic panel, for instance, the display panel size is limited, and no one can write information outside the screen. The user should erase the former information for writing further information. It is not so convenient. If the presenter or teacher requires opening several files at the same time, the user should switch among the files frequently by click icons. Further, the current system cannot offer dual way activities between the student and the teacher for the teaching and presentation.

What is required is a more convenient and friendly system.

### SUMMARY OF THE INVENTION

In view of the aforementioned defects of the conventional method, the present invention discloses a multiple touch presenting system and method of the same.

A method of operating presentation through a multi-touch panel comprises providing a presenting module having a format transformation module, user interface generator and presenting/reading mode switching module to a computing system. The next step is to activate the presenting module and display interface generated by the user interface generator on a multiple-touch panel of the system, wherein the interface generated by the user interface generator includes a shrinkage image area to display the non-activated file, an operation area to display file which is activated and a buffer zone to allow a user drag file in the shrinkage image area to the operation area, thereby activating the dragged file, followed by determining whether touch event of the user is multiple or not by the computing system; if the determination is positive, followed by determining whether area occupied by the activated file is greater than a threshold or not, if positive, then, the activated file is processed by enlarging, shrinking or rotating, otherwise, switching to a presenting mode; and if the determination of multiple is negative, followed by determining whether the activated file is beyond boundary of the operation area, if positive, then, closing the activated file and displaying corresponding image icon in the shrinkage image area, otherwise, moving the activated file.

The threshold is seventy to eighty-five percentages of the operation area. Preferably, the threshold is eighty percentages of the operation area. The method further comprises an initiation step and executing back stage step which includes step of selecting company logo, logo color, background color, version, frame color, horizontal rotation function or file directory.

The method after switching to the reading mode further comprises a step of determining whether brush function is selected, if positive, an editing mode is activated, otherwise, a finger recognition step is activated to determine whether the mode of switching or page-turning is selected. The presenting module is stored into a computer readable medium to execute the method of operating presentation through a multi-touch panel.

A method of operating presentation through a multi-touch panel, comprises providing a presenting module having a format transformation module, user interface generator and presenting/reading mode switching module to a computing system; activating the presenting module and display interface generated by the user interface generator on a multiple-touch panel of the system, wherein the interface generated by the user interface generator includes a shrinkage image area to display the non-activated file, an operation area to display file which is activated and a buffer zone to allow a user drag file in the shrinkage image area to the operation area, thereby activating the dragged file; extracting file list to determine which file will be activated; and if the file is still image format or motion picture format, followed by recording the file list, otherwise transformation the file into the still image format or the motion picture format before recording the file list; activating till image displayer or motion picture displayer to display the file on the operation area based on format or transformed format of the file.

A presentation system comprises processor; a storing device is coupled to the processor; a multiple-touch panel is coupled to the processor which can recognize touch event on the multiple-touch panel, followed by executing the touch event instruction; a presenting module having a format transformation module, user interface generator and presenting/reading mode switching module to a computing system, wherein the presenting module is activate and an interface generated by the user interface generator on a multiple-touch panel, wherein the interface generated by the user interface generator includes a shrinkage image area to display the non-activated file, an operation area to display file which is activated and a buffer zone to allow a user to drag file in the shrinkage image area to the operation area, thereby activating the dragged file. The multiple-touch panel can sense at least two touching events to allow fingers of a user to manipulate virtual object in the multiple-touch panel.

### BRIEF DESCRIPTION OF THE DRAWINGS

The present invention may be understood by some preferred embodiments and detailed descriptions in the specification and the attached drawings below. The identical reference numbers in the drawings refer to the same components in the present invention. However, it should be appreciated that all the preferred embodiments of the invention are only for illustrating but not for limiting the scope of the Claims and wherein:

FIG. 1 is a diagram of the presenting system according to the present invention.

FIG. 2 is a flow chart according to the present invention.

FIG. 3 is a flow chart according to the present invention.

FIG. 4 is a flow chart according to the present invention.

FIG. 5 is diagram of the presenting system according to the present invention.

### DETAILED DESCRIPTION OF THE PREFERRED EMBODIMENT

The invention will now be described with the preferred embodiments and aspects and these descriptions interpret structure and procedures of the invention only for illustrating but not for limiting the Claims of the invention. Therefore, except the preferred embodiments in the specification, the present invention may also be widely used in other embodiments.

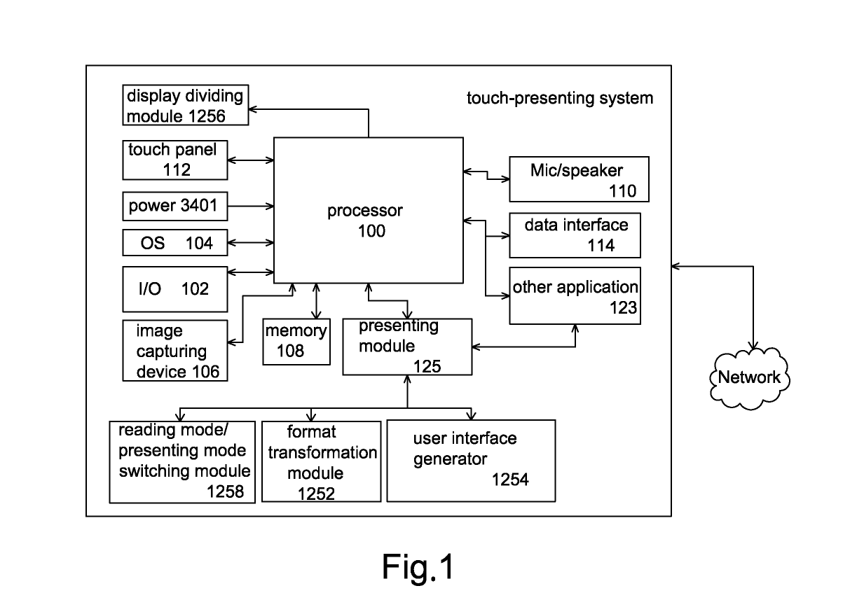

FIG. 1 shows the system of the present invention. The multi-touch control system includes processor 100 to control and process the data. An output unit 102, operation system 104, image capturing device 106 is provided to capture the image are all coupled to the processor 100. Memory or computer readable media recorder 108 is coupled to the processor 100. It may be hard drive, ROM, RAM, non-volatile memory (such as FLASH). Vocal signal is transmitted to the speaker/microphone unit 110. The system includes touch control display panel 112, and the interface 114 may allow the user to input/output information with the external device.

The output unit 102, and touch control display panel 112 are coupled to the processor. The input device 102 allows the user to input instruction to the process or 100 to execute the instruction and operate the system, and to display the interface of the OS 104 and the application 123 by the touch control display panel 112.

In one preferred embodiment, the input device 130 includes keyboard, mouse and the touch control display panel 112 includes touch control sensors. The types of the sensors include, but are not limited to, capacitor type, resist-type, IR type, SAW type. In one case, the user may utilize the touch control display panel 112 to input information directly and straight forwardly. The touch control display panel 112 may be one or multi-touch control. The user may control the virtual objects by the fingers if the panel is multi-touch control. The touch control display panel 112 may be altered by other type of display based on the requirement.

The multi-touch operating system includes the interface 114 to couple to the external device and transmit information by network. The network may be wired or wireless network, for instance, to receive the web page through mobile phone. The protocols of the mobile phone include dual way protocol, such as GSM [symbol] CDMA [symbol] PHS [symbol] 3G [symbol] 3.5G [symbol] 4G. The communication module may receive the information offered by the service provider and be decoded and transformed into recognized signal by the mobile phone. The communication module of the device includes processor and user interface for input instruction by touching or vocal. The communication module of the device may output data in its memory for further processing such as decoding, recognition. The present invention includes an integration application module 125 which includes format transformation module 1252 and user interface generator 1254, display dividing module 1256 and presentation module 1258. The presentation module 1258 supports the formats of JPG [symbol] GIF [symbol] PNG [symbol] BMP [symbol] PPT [symbol] PPTX [symbol] AVI [symbol] MPEG [symbol] MPG [symbol] WMV [symbol] ASF [symbol] MP4. By using the multi-touching panel, the virtual object can be enlarging, shrinkage, directly and straight forwardly, and the mode of full-screen PPT mode can be achieved easily. The backstage opens the functions to allow the user to edit the stylish to show the person style.

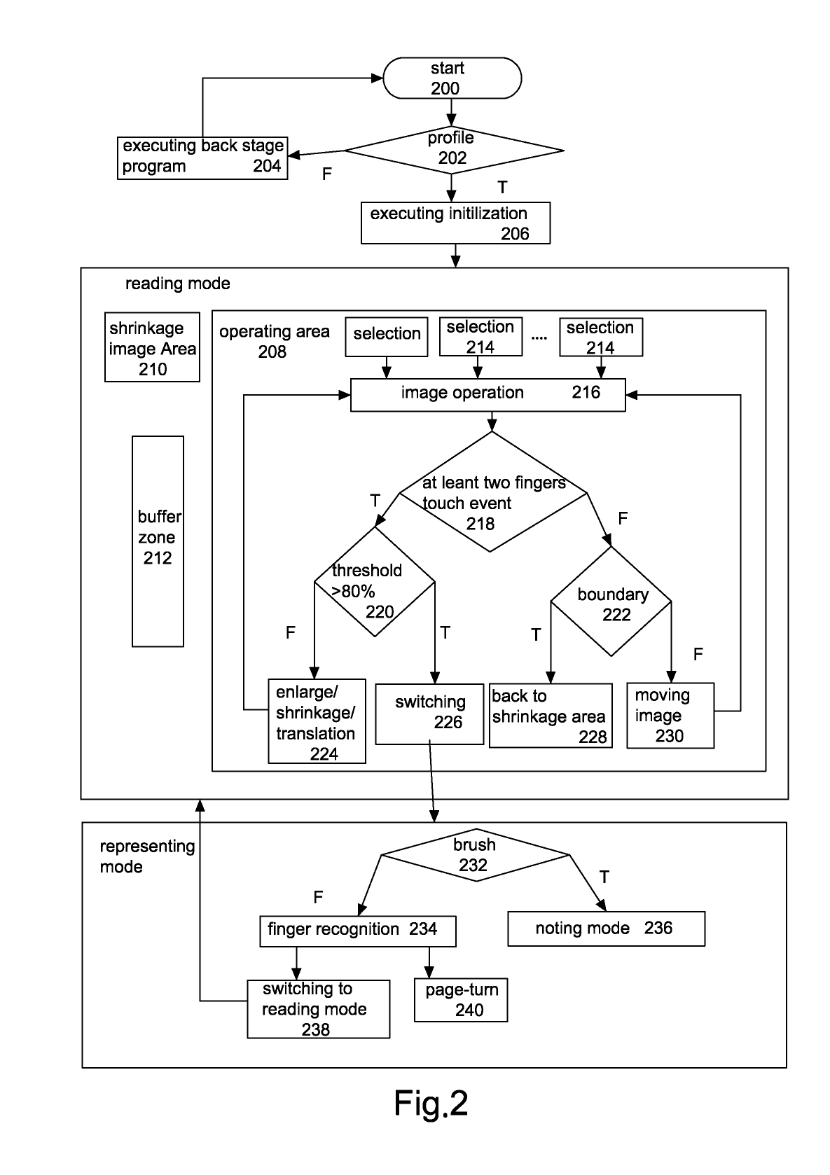

Please refer to FIG. 1 and FIG. 2, it shows the present system accompanying with the operating method of the front stage. The presenting module is stored in the computer readable medium. The input device 102 is connected to the processor 100 and the processor may recognize the finger located on the multi-touch panel to process the pre-determined instruction input from the finger to click the virtual object in the operation area defined by the software or application on the user interface. First, the initial step is to activate the presentation module program, followed by check whether or not there is a profile in step 202. If there is no profile, then backstage application is executed in step 204. If the determination is positive, then initialization process is executed in step 206. After the initialization, the user may select the mode including presenting mode or reading mode. The presenting mode or reading mode will be activated according to the mode selected by the user. Both of the modes benefit to reading or presenting for the user, respectively. If the selection is reading mode, the user interface generator 1254 will generate the interface corresponding to the reading mode which includes operation area 208, a shrinkage area 210 and a buffer zone 212. The shrinkage area 210 is used to display and arrange the files which are shrinkage for the user to select and recognize the files. If the user would like to open (activate) or enlarge the files within the shrinkage area 210, the user just drags the files to the buffer zone 212, when the processor and the application recognize the action, the dragged file will be enlarged and display within the operation area 208, dragged by the mouse is not required. The user may edit and operate the file within the operation area 208. For example, the user drags the shrinkage image or icon 214, and the presenting module 125 will open the corresponding file in the operation area 208. When the user operates the files, the presenting module 125 and the multi-touch panel 112 will determine whether or not the touch is multi-touch, for example two-point touch in step 218.

In one embodiment, the multi-touch display panel 112 transmits the touch event to the processor 100 to determine and recognize the event with the presenting module 125. The processor 100 will determine whether the area occupied by the image or file touched by the finger is greater than a threshold or not in step 222. If the image file occupied the area is higher than 80 percentage of the operating area, then transformed from reading mode to presenting mode in step 224. Otherwise, the imaged will be treated with enlarged, shrinkage or translate based on the finger movement, such as fingers approaching, fingers separating.

If the judgment of above step is not the touching event, then the processor determines whether the touched file beyond (cross) the boundary of the operating area 208 or not. If positive, the opened file backs to the shrinkage image area 228, otherwise, it will be the signal of moving file 230.

If there is switching step from reading mode to presenting mode, then it will determine where or not the editing tool (such as brush) is selected in step 232. If positive, it will be recognized that the action is to switch to editing mode 236 to allow the user uses the editing tool to take note or write words on the screen. Otherwise, the finger action recognition processed will be executed such as switching 238 or turning page 240.

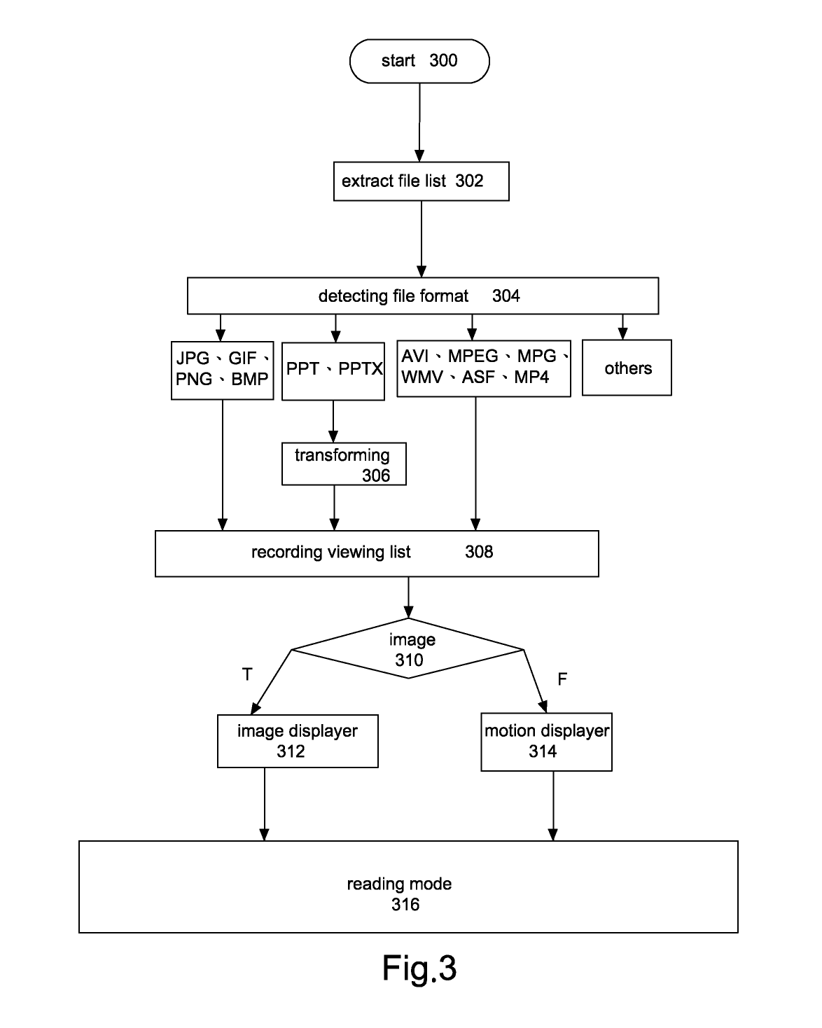

FIG. 3 illustrates the viewing step block diagram according to the present invention. Initially, step 300, the main program 300 is activated, and extracts the files list in step 302. Subsequently, the system determines or detects what type of the file type is in step 304. Typically, the files is classified into four types: still image such as JPG [symbol] GIF [symbol] PNG [symbol] BMP, motion picture such as AVI [symbol] MPEG [symbol] MPG [symbol] WMV [symbol] ASF [symbol] MP4, presenting file format, for instance, PPT, PPTX, and others. If the file is still image, motion picture, then the system will execute the step 308 of recording the viewing list. Otherwise, the format transformation module 1252 will convert the files 306, followed by executing the step 308 of recording the viewing list. Subsequent step is to determine whether or not the file is image file in step 310. If the determination is positive, the system will activate or call the image file displayer to display the image file. Otherwise, the system activates the motion picture displayer to display the motion picture. The steps maybe altered and the mode could be switched to reading mode 316 at any event.

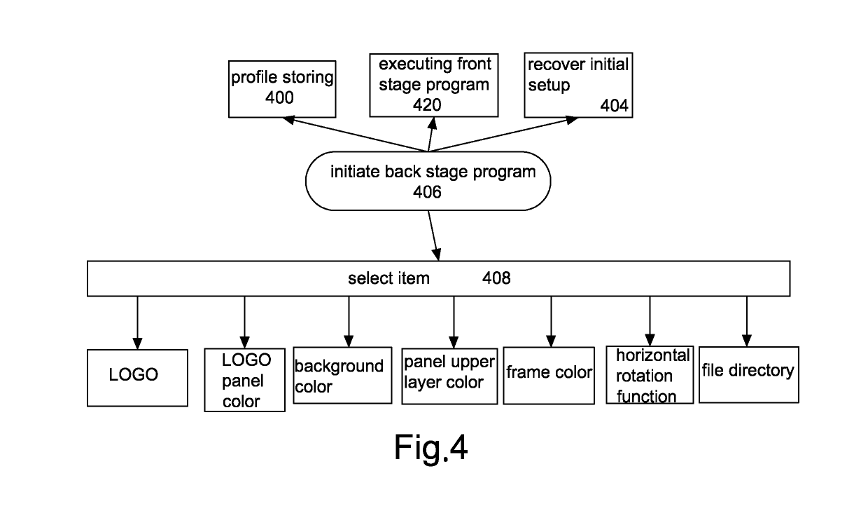

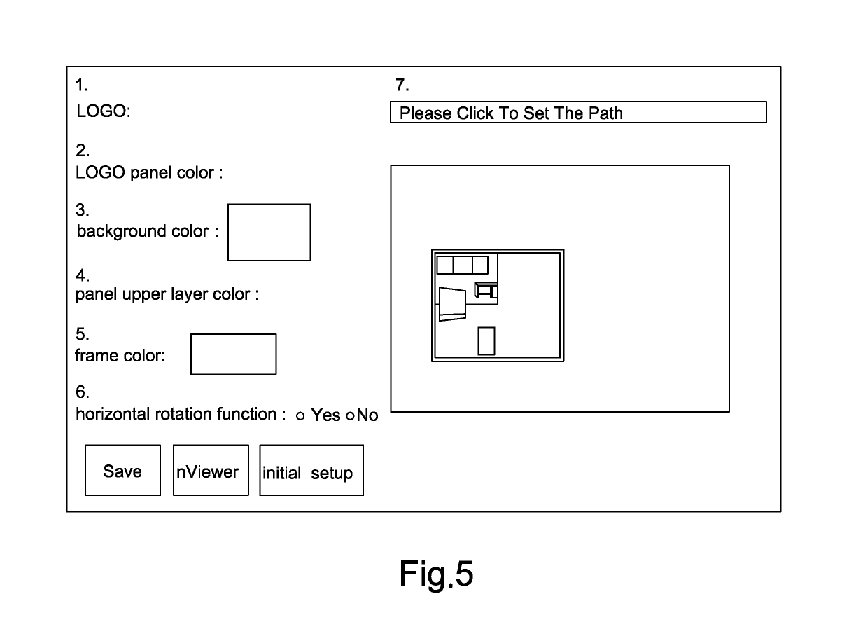

FIG. 4 illustrates the flow chart for the backstage of the presentation module according to the present invention. It includes profile storing procedure in 400, and executing the front stage procedure and the recovering initial profile procedure. The backstage program is initiated, initially in step 406, followed by selecting the item, such as company logo, logo color, background color, version, frame color and the horizontal rotation function and short cut for reading, required to be altered in step 408. The backstage can be edited by the user as shown in FIG. 5.

The presentation module 125 can be installed in storage device or memory 108 in the OS 104 environment, and is loaded for executed the presentation module 125 by the processor 100, thereby displaying the interface on the multiple touch panel 112. In one embodiment, the presentation module 125 can be applied to the teaching program or representing program. However, it should be note, only a part of the presentation module 125 is illustrated and it is not limited to the illustration.

The interface of the presentation module 125 may be defined with an operating area, and multiple instructions to allow the user to implement the function of writing or illustrating action within the operation area. The operation area includes virtual objects, but not limited to, those who having ordinary skill in the art may know or understand that more virtual object or tool, alias icon are also possible to be provided.

The processor 100 will recognize the information input from the locations on the multiple-touch panel 112 when the user operates the interface through the multiple-touch panel 112. In one embodiment, the multiple-touch panel 112 allows the user clicking or selecting the virtual objectors within the multiple-touch panel 112. The user may input data from the mouse as well, followed by clicking or selecting the virtual objectors within the multiple-touch panel 112 to control the virtual objector by the user via the function menu of the multiple-touch panel 112.

Pluralities of functions are provided within the interface to allow the user controlling and the function menu is set at the edges of the operation area. When the user touches the edge, it will trigger the action of displaying the function menu and the displayed function menu allows the user to make a selection. The event will happen when the user employs the input device 130 as well. The function list in the menu includes but not limited to rotation, enlarging and shrinking, or translating (moving). It might include the function of rotating the function menu to offer the intuition operation method.

Therefore, the user may manipulate the virtual objects by the present invention with more intuition method to let them rotate, enlarge, squeeze, or translate. The switching between the presenting mode and reading mode become easy. Furthermore, the presenting application module may open different files with different format, the user does not need to switch application programs. In order to achieve the multi-people operation, the panel 112 may be divided into multiple areas for multi-people operation at the same time by the display dividing module 1256. Thus, the display dividing module 1256 is coupled to the processor 100 to divide the display into at least two independent sections including two user interfaces.

The present invention may supports multiple file format including, but not limited to, JPG [symbol] GIF [symbol] PNG [symbol] BMP [symbol] AVI [symbol] MPEG [symbol] MPG [symbol] WMV [symbol] ASF [symbol] MP4. The user may feed into required file into the presenting module 125 and active and open these files through the processor 100, thereby manipulating the single module may open each kind of format, easily. Thus, other types of applications 123 are not required. The present invention may omit the inconvenience process and switching steps and intuition operation method is achieved.

As indicated above, the present invention offer multiple-people operation method and virtual object manipulation method to allow the user may operating the system and virtual object more convenience and intuition to improve the effect and performance of the presentation teach.

The foregoing description is a preferred embodiment of the present invention. It should be appreciated that this embodiment is described for purposes of illustration only, not for limiting, and that numerous alterations and modifications may be practiced by those skilled in the art without departing from the spirit and scope of the invention. It is intended that all such modifications and alterations are included insofar as they come within the scope of the invention as claimed or the equivalents thereof.

What is claimed is:

1. A method of operating presentation through a multi-touch panel, comprising:
providing a presenting module having a format transformation module, user interface generator and presenting/reading mode switching module to a computing system;
activating said presenting module and display interface generated by said user interface generator on a multiple-touch panel of said system, wherein said interface generated by said user interface generator includes a shrinkage image area to display the non-activated file, an operation area to display file which is activated and a buffer zone to allow a user to drag file in said shrinkage image area to said operation area, thereby activating said dragged file;
determining whether touch event of said user is multiple or not by said computing system;
if said determination is positive, followed by determining whether area occupied by said activated file is greater than a threshold or not, if positive, then, enlarging, shrinking or rotating said activated file, otherwise, switching to a presenting mode; and
if said determination of multiple is negative, followed by determining whether said activated file is beyond boundary of said operation area, if positive, then, closing said activated file and displaying corresponding image icon in said shrinkage image area, otherwise, moving said activated file.

2. The method structure of claim 1, wherein said threshold is seventy to eighty-five percentages of said operation area.

3. The method structure of claim 2, wherein said threshold is eighty percentages of said operation area.

4. The method structure of claim 1, further comprising initiation step.

5. The method structure of claim 1, further comprising a step of executing back stage step.

6. The method structure of claim 5, wherein said step of executing back stage step including selecting company logo, color, background color, version, frame color, horizontal rotation function or file directory.

7. The method structure of claim 1, after switching to said reading mode further comprising a step of determine whether editing function is selected, if positive, an editing mode is activated, otherwise, a finger recognition is activated to determine whether switch or page-turn is selected.

8. The method structure of claim 1, wherein said presenting module is stored into a computer readable medium to execute said method of operating presentation through a multi-touch panel.

9. A method of operating presentation through a multi-touch panel, comprising:
providing a presenting module having a format transformation module, user interface generator and presenting/reading mode switching module to a computing system;
activating said presenting module and display interface generated by said user interface generator on a multiple-touch panel of said system, wherein said interface generated by said user interface generator includes a shrinkage image area to display the non-activated file, an operation area to display file which is activated and a buffer zone to allow a user drag file in said shrinkage image area to said operation area, thereby activating said dragged file;
extracting file list to determine which file will be activated; and
if said file is still image format or motion picture format, followed by recording said file list, otherwise transformation said file into said still image format or said motion picture format before recording said file list; activating till image displayer or motion picture displayer to display said file on said operation area based on format or transformed format of said file.

10. The method structure of claim 9, wherein said presenting module is stored into a computer readable medium to execute said method of operating presentation through a multi-touch panel.

11. A method of operating presentation through a multi-touch presenting system, comprising:
providing a multiple-touch panel coupled to a processor of a computing system which can recognize touch event on said multiple-touch panel, followed by executing said touch event instruction;
providing a presenting module having a format transformation module, user interface generator and presenting/reading mode switching module to said computing system, wherein said presenting module is activate and an interface generated by said user interface generator on a multiple-touch panel, wherein said interface generated by said user interface generator includes a shrinkage image area to display the non-activated file, an operation area to display file which is activated and a buffer zone to allow a user to drag file in said shrinkage image area to said operation area, thereby activating said dragged file;
activating said presenting module and display interface generated by said user interface generator on a multiple-touch panel of said computing system;
determining whether touch event of said user is multiple or not by said computing system;
if said determination is positive, followed by determining whether area occupied by said activated file is greater than a threshold or not, if positive, then, enlarging, shrinking or rotating said activated file, otherwise, switching to a presenting mode; and
if said determination of multiple is negative, followed by determining whether said activated file is beyond boundary of said operation area, if positive, then, closing said activated file and displaying corresponding image icon in said shrinkage image area, otherwise, moving said activated file.

12. The method of claim 11, wherein said multiple-touch panel can sense at least two touching events to allow fingers of a user to manipulate virtual object in said multiple-touch panel.
